(19) United States
(12) Patent Application Publication
(10) Pub. No.: US 2013/0066954 A1
(43) Pub. Date: Mar. 14, 2013

(54) COMPUTER SOFTWARE ANALYSIS SYSTEM, CLIENT COMPUTER, METHOD OF CONTROLLING OPERATION OF SAME AND OPERATION PROGRAM THEREFOR

(71) Applicant: Masaya NAGASE, Tokyo (JP)

(72) Inventor: Masaya NAGASE, Tokyo (JP)

(73) Assignee: FUJIFILM Corporation, Tokyo (JP)

(21) Appl. No.: 13/550,485

(22) Filed: Jul. 16, 2012

(30) Foreign Application Priority Data
Sep. 14, 2011 (JP) 2011-200340

(51) Int. Cl. G06F 15/16

(52) U.S. Cl. 709/203

(57) ABSTRACT

The security of source code is maintained when computer software is analyzed. To achieve this, computer software to undergo analysis is obfuscated in a client computer. The obfuscated computer software is transmitted to a server computer. Software analysis is performed in the server computer and data representing the result of this analysis is transmitted to the client computer. Since the data representing the result of analysis has thus been obfuscated, the contents of the computer software cannot be ascertained in the server computer. The obfuscated data representing the result of analysis is restored to the original in the client computer.

### BACKGROUND OF THE INVENTION

1. Field of the Invention

This invention relates to a computer software analysis system, a client computer, a method of controlling operation of the client computer and a program for operating the client computer.

2. Description of the Related Art

Techniques for analyzing software have come of age in recent years. For example, a typical technique involves outputting quality-related data from source code and utilizing the data in activities that improve quality. Such techniques are widely applicable and in view of the recent tendency toward placing importance upon the internal quality of software, it is predicted that a wide variety of such techniques and services will be developed.

In software analysis technology, extensive computer resources are required for the software analysis per se but these are not made to operate constantly with respect to specific software. Further, in instances where software is transmitted, the transmitted data per se conforms to the source code (text data) and the amount of data involved is small in comparison with image data and moving-image data. In view of these characteristics, software analysis lends itself well to the recent trend toward cloud computing (the effective exploitation of network-based computer resources). For this reason it is believed that applications which analyze source code using cloud-based software analysis systems will find widespread use in the future.

Such software analysis includes one arrangement in which a client transmits source code to a server and the server carries out the analysis and sends the analytical result back to the client (see Patent Document 1), and another arrangement in which a client generates quality-measurement data and transmits this data to a server, and the server generates evaluation data based upon this quality-measurement data and sends the evaluation data back to the client (see Patent Document 2).

On the other hand, obfuscation is known as a means of maintaining the security of source code. For the purpose of impeding third-party software analysis, obfuscation generally applies a form of scrambling to software code to a degree that will not alter its behavior. For example, the practice of attaching names that are easy to understand in the source-code description is utilized in reverse to replace these names with ones difficult to understand, thereby complicating analyzability (see Patent Document 3).

Further, there is art for preventing the leakage of technical know-how included in a program (see Patent Document 4), for monitoring compliance with an agreement during software development (see Patent Document 5), for identifying program problems and the like (see Patent Document 6) and for achieving concealment at the object level (see Patent Document 7).

[Patent Document 1] Japanese Patent Application Laid-Open No. 2004-240477

[Patent Document 2] Japanese Patent Application Laid-Open No. 2001-75928

[Patent Document 3] U.S. Pat. No. 6,102,966

[Patent Document 4] Japanese Patent Application Laid-Open No. 2004-133793

[Patent Document 5] Japanese Patent Application Laid-Open No. 2003-131875

[Patent Document 6] Japanese Patent Application Laid-Open No. 2003-114813

[Patent Document 7] Japanese Patent Application Laid-Open No. 2003-280754

However, transmitting source code to a cloud-based server means transmitting the source code over a public network. Although encrypting the source code is conceivable, the fact that the analyzing server decrypts the source code means that the server will learn the content of the source code. The prior art described in Patent Document 1 will not assure the security of source code. The system set forth in Patent Document 2 has a number of problems. For example, the client is required to have a quality measurement function and it is necessary to agree upon a special exchange data format between the client and server. In addition, no consideration is given to the detailed collation of data, which has been sent back from the server, with the original source code. Further, in a case where it is desired to add on software information necessary for analysis, it is necessary to revise the client. In a case where software information necessary for analysis has been added on, the security of source code suffers. The arrangement described in Patent Document 3 has certain problems, namely the fact that no consideration is given to linkage with a server/client-type analysis system and the fact that the restoration of obfuscated names is not taken into account. Furthermore, with the arrangements described in Patent Documents 4 to 7, no consideration is given to a server/client-type analysis system capable of maintaining the security of source code.

### SUMMARY OF THE INVENTION

A first object of the present invention is to provide a server-client software analysis system capable of maintaining the security of source code. A second object is to make it unnecessary for a client computer to have analyzing means. A third object is to make it unnecessary to agree upon a special data format for transmitting source code from a client computer to a server computer. For example, the third object is to arrange it so that, by making it unnecessary for a server computer to have special means for implementing source code security, the server computer can be combined with a system that does not take source code security into account. A fourth object is to arrange it so that data sent back from a server computer can be readily checked against the original source code. A fifth object is to arrange it so that the adding on and changing of analytical content can be dealt with substantially by a server computer alone. A sixth object is to arrange it so that source code security can be maintained even if analyzing means is added on or changed. A seventh object is to arrange it so that various already existing software obfuscation means can be readily combined.

The present invention relates to a computer software analysis system comprising a client computer and a server computer.

The client computer includes a computer software obfuscation device (computer software obfuscation means) for obfuscating computer software to undergo analysis; and an obfuscated computer software transmitting device (obfuscated computer software transmitting means) for transmitting the computer software, which has been obfuscated by the computer software obfuscation device, to the server computer. The server computer includes a computer software analyzing device (computer software analyzing means) for analyzing the obfuscated computer software, which has been transmitted from the obfuscated computer software transmitting device of the client computer, and generating obfuscated analytical-result data; and an analytical-result data transmitting device (analytical-result data transmitting means) for transmitting the obfuscated analytical-result data, which has been generated by the computer software analyzing device, to the client computer. The client computer further includes a restoration device (restoration means) for restoring at least part of the obfuscated analytical-result data, which has been transmitted from the analytical-result data transmitting device of the server computer, to analytical-result data that prevailed prior to obfuscation.

The present invention also provides a client computer which constitutes the computer software analysis system described above. Specifically, the client computer comprises a computer software obfuscation device for obfuscating computer software to undergo analysis; an obfuscated computer software transmitting device for transmitting the computer software, which has been obfuscated by the computer software obfuscation device, to a server computer; a receiving device (receiving means) for receiving obfuscated analytical-result data, which is generated by analyzing, in the server computer, the obfuscated computer software transmitted from the obfuscated computer software transmitting device, and which is transmitted from the server computer; and a restoration device for restoring at least part of the obfuscated analytical-result data, which has been received by the receiving device, to analytical-result data that prevailed prior to obfuscation.

Furthermore, the present invention provides an operation control method suited to the above-described client computer. Specifically, the invention provides a method of controlling operation of a client computer comprising the steps of: an obfuscation device obfuscating computer software to undergo analysis; an obfuscated computer software transmitting device transmitting the computer software, which has been obfuscated by the computer software obfuscation device, to a server computer; a receiving device receiving obfuscated analytical-result data, which is generated by analyzing, in the server computer, the obfuscated computer software transmitted from the obfuscated computer software transmitting device, and which is transmitted from the server computer; and a restoration device restoring at least part of the obfuscated analytical-result data, which has been received by the receiving device, to analytical-result data that prevailed prior to obfuscation.

The present invention also provides a program for controlling the operation of the client computer described above. An arrangement may be adopted in which such a program stored in a recording medium is provided.

In accordance with the present invention, computer software to be analyzed is obfuscated in a client computer. The obfuscated computer software is transmitted from the client computer to a server computer. When the obfuscated computer software is transmitted from the client computer to the server computer, the server computer analyzes the quality of the obfuscated computer software and generates obfuscated analytical-result data. The obfuscated analytical-result data is transmitted from the server computer to the client computer. At least part of the obfuscated analytical-result data is restored to the analytical-result data that prevailed prior to obfuscation.

Since the analytical-result data obtained in the server computer has been obfuscated, the contents of the computer software can be prevented from being ascertained on the side of the server computer. The security of the computer software can thus be maintained. Since analysis of the computer software is performed in the server computer, the client computer need not be provided with the function of a computer software analyzing device. The server computer need not be provided with a special arrangement in order to maintain the security of the computer software. Since the client computer has obfuscated the computer software, it can also restore the obfuscated analytical-result data comparatively easily. Since the analysis has been carried out in the server computer, the adding on and changing of analytical contents can be dealt with by the server computer alone. Since the computer software is analyzed in the obfuscated state, the security of the computer software can be maintained even if the an analyzing device is added on or changed. Various already existing software obfuscation devices can be combined as well.

The client computer may further include an output device (output means) for outputting the computer software that has been obfuscated by the computer software obfuscation device.

The client computer may further include an analysis control data transmitting device (analysis control data transmitting means) for transmitting analysis control data, which controls analysis of the obfuscated computer software in the computer software analyzing device of the server computer, to the server computer. In this case, the computer software analyzing device of the server computer would analyze the obfuscated computer software by utilizing the analysis control data transmitted from the analysis control data transmitting device of the client computer.

The client computer may further include a designating device (designating means) for designating, in the analysis control data, analysis control data requiring obfuscation; and an analysis control data obfuscation device (analysis control data obfuscation means) for obfuscating the analysis control data designated by the designating device. In this case, the analysis control data transmitting device of the client computer transmits at least one of the analysis control data obfuscated by the analysis control data obfuscation device and the analysis control data that has not been obfuscated to the server computer, by way of example.

The computer software analysis system may further comprise an analytical-result control data input device (analytical-result control data input means) for inputting analytical-result control data that controls the analytical-result data received by the client computer; and an analytical-result data control device (analytical-result data control means) for controlling the obfuscated analytical-result data or analytical-result data restored by the restoration device, based upon the analytical-result control data that has been input from the analytical-result control data input device.

The client computer may further include an obfuscation method selecting device (obfuscation method selecting means) for selecting one obfuscation method from among a plurality of obfuscation methods. In this case, the computer software obfuscation device of the client computer obfuscates the computer software by the obfuscation method selected by the obfuscation method selecting device, by way of example.

The computer software obfuscation device of the client computer may delete some of the computer software or may mix in unrelated software and obfuscate the remaining portion of the computer software.

The client computer may further include an analytical item designating device (analytical item designating means) for designating an item that will be analyzed by the computer software analyzing device of the server computer; an obfuscation method deciding device (obfuscation method deciding means) for deciding upon an obfuscation method, which corresponds to the analytical item designated by the analytical item designating device, from among a plurality of obfuscation methods; and a removable-portion deciding device (removable-portion deciding means) for deciding a removable portion in the computer software in a case where obfuscation based upon the obfuscation method decided by the obfuscation method deciding device is carried out. In this case, the computer software obfuscation device of the client computer deletes the portion decided by the removable-portion deciding device from the computer software and obfuscates the remaining portion of the computer software, by way of example.

In a case where a removable portion has been stipulated in the computer software in association with each analytical item and obfuscation method, the obfuscation method deciding device would decide an obfuscation method, which has been stipulated in association with the analytical item designated by the analytical item designating device, corresponding to the removable portion in the computer software, by way of example.

The computer software obfuscation device of the server computer outputs the same obfuscated computer software when the same computer software is obfuscated, by way of example.

The server computer may further include an analytical-result data storage device (analytical-result data storage means) for storing analytical-result data, which has been restored in the computer software analyzing device, in association with computer software; and a comparison device (comparison means) for comparing analytical-result data, which has been generated in the computer software analyzing device by analyzing the obfuscated computer software transmitted from the computer software transmitting device, and analytical-result data that has been stored in the analytical-result data storage device in association with the computer software of the generated analytical-result data, and outputting result of the comparison.

The client computer may further include an obfuscation method storage device (obfuscation method storage means) for storing the obfuscation method, which has been carried out by the computer software obfuscation device of the client computer, in association with the computer software. In this case, the computer software obfuscation device of the client computer, when it performs obfuscation with regard to new computer software, obfuscates the computer software using the obfuscation method that has been stored in the obfuscation method storage device in association with this computer software, by way of example.

The obfuscation method storage device of the client computer stores an obfuscation method and an analytical item, which have been implemented by the computer software obfuscation device of the client computer, in association with the computer software, by way of example. In this case, the computer software obfuscation device of the client computer may further include an analytical item transmitting device (analytical item transmitting means) for transmitting an analytical item, which has been stored in the obfuscation method storage device in association with new computer software, to the server computer when the computer software obfuscation device performs obfuscation with regard to the new computer software.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

FIG. 1 illustrates an overview of a computer software analysis system;

FIG. 2 is a block diagram illustrating the electrical configuration of a client computer;

FIG. 3 is a flowchart illustrating processing executed by the client computer;

FIG. 4 is a flowchart illustrating processing executed by a server computer;

FIG. 5 illustrates an example of original computer software;

FIG. 6 illustrates an example of obfuscated computer software;

FIG. 7 illustrates an example of a restoration table;

FIG. 8 illustrates an example of obfuscated analytical-result data;

FIG. 9 illustrates an example of restored analytical-result data;

FIG. 10 is a flowchart illustrating a portion of processing executed by a client computer;

FIG. 11 is a flowchart illustrating processing executed by a server computer;

FIG. 12 illustrates an example of original computer software;

FIG. 13 illustrates an example of an analysis control data obfuscation table;

FIG. 14 illustrates an example of analysis control data;

FIG. 15 illustrates an example of obfuscated computer software;

FIG. 16 illustrates an example of analysis control data;

FIG. 17 illustrates an example of program element/analysis control data;

FIGS. 18 and 19 illustrate examples of analytical results;

FIGS. 20 and 21 are flowcharts illustrating processing executed by a client computer;

FIG. 22 illustrates an example of original computer software;

FIG. 23 illustrates an example of a list of analytical items;

FIG. 24 illustrates an example of a list of obfuscation methods;

FIGS. 25 to 27 illustrate examples of obfuscated computer software;

FIGS. 28 and 29 illustrate examples of analytical results;

FIG. 30 is a flowchart illustrating processing for deciding an obfuscation method;

FIG. 31 illustrates an example of an obfuscation method/deletion item specifying table;

FIG. 32 illustrates an example of an analytical item/removable item specifying table;

FIG. 33 is a flowchart illustrating processing for deciding an obfuscation method;

FIG. 34 illustrates the corresponding relationship between analytical items and obfuscation methods;

FIG. 35 is a flowchart illustrating a portion of processing executed by a client computer;

FIG. 36 is a flowchart illustrating processing executed by a client computer;

FIG. 37 illustrates an example of data representing a history of software analysis settings;

FIG. 38 illustrates an example of data representing past software history; and

FIG. 39 illustrates an example of analysis comparison data.

### DESCRIPTION OF THE PREFERRED EMBODIMENTS

Embodiments of the present invention will now be described in detail with reference to the drawings.

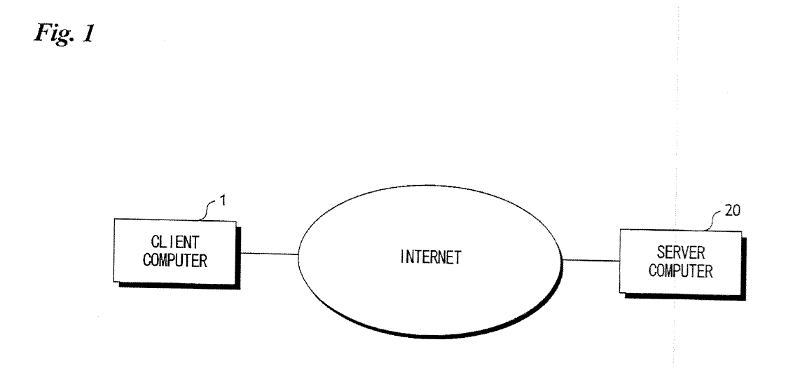

FIG. 1 illustrates a computer software analysis system according to an embodiment of the present invention.

The computer software analysis system includes a client computer 1 and a server computer 20 capable of communicating with each other via a network such as the Internet (although the network is not limited to the Internet).

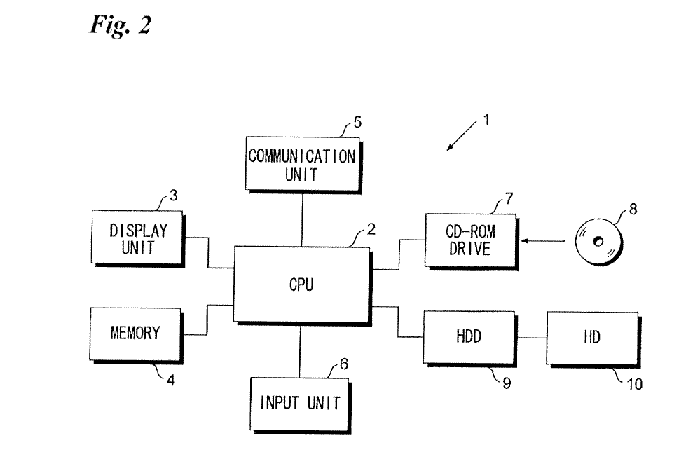

FIG. 2 is a block diagram illustrating the electrical configuration of the client computer 1. The electrical configuration of the server computer 20 also is substantially the same as that of the client computer 1.

The overall operation of the client computer 1 is controlled by a CPU 2.

The client computer 1 includes a display unit 3; a memory 4 for storing prescribed data; a communication unit 5 for communicating with the server computer 20; an input unit 6 such as a keyboard; a CD-ROM drive 7; a hard disk 10; and a hard-disk drive 9 for accessing the hard disk 10.

By inserting a CD-ROM 8 into the CD-ROM drive 7, data and computer software, which have been stored on the CD-ROM 8, are read. A control program for controlling operation, described later, has been stored on the CD-ROM 8. By installing this control program in the client computer 1, operation described later is carried out. The control program may of course be recorded on another recording medium rather than being stored on the CD-ROM 8. A control program that has been transmitted via the Internet may be received using the communication unit 5 and installed in the client computer 1.

FIG. 3 is a flowchart illustrating processing executed by the client computer 1, and FIG. 4 is a flowchart illustrating processing executed by the server computer 20.

This embodiment analyzes computer software (source code) quality such as number of lines of code, cohesion, complexity and connectivity, and the analysis of such quality is carried out in the server computer 20. Obfuscation of the computer software is performed in the client computer 1 in such a manner that the results of analysis cannot be ascertained in the server computer 20, and the obfuscated computer software is transmitted from the client computer 1 to the server computer 20.

First, original computer software (source code) to be undergo analysis is input to the client computer 1 (step 31 in FIG. 3). As set forth above, the computer software to be analyzed has been stored on the CD-ROM 8 and may be input to the client computer 1 by reading it from the CD-ROM 8. Computer software transmitted via the Internet may be received using the communication unit 5 and then input to the client computer 1.

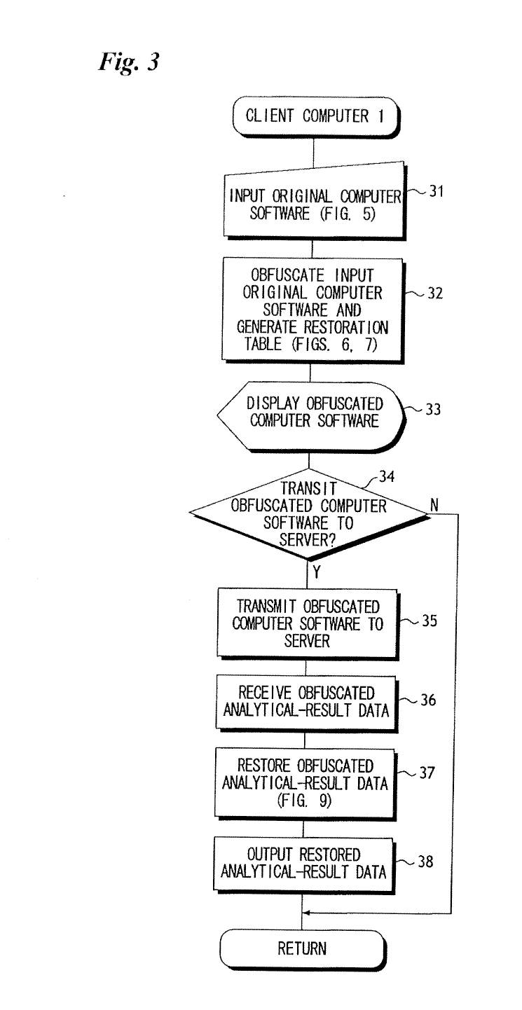

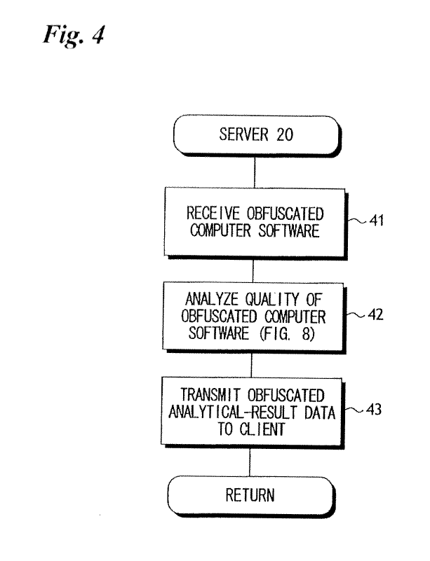

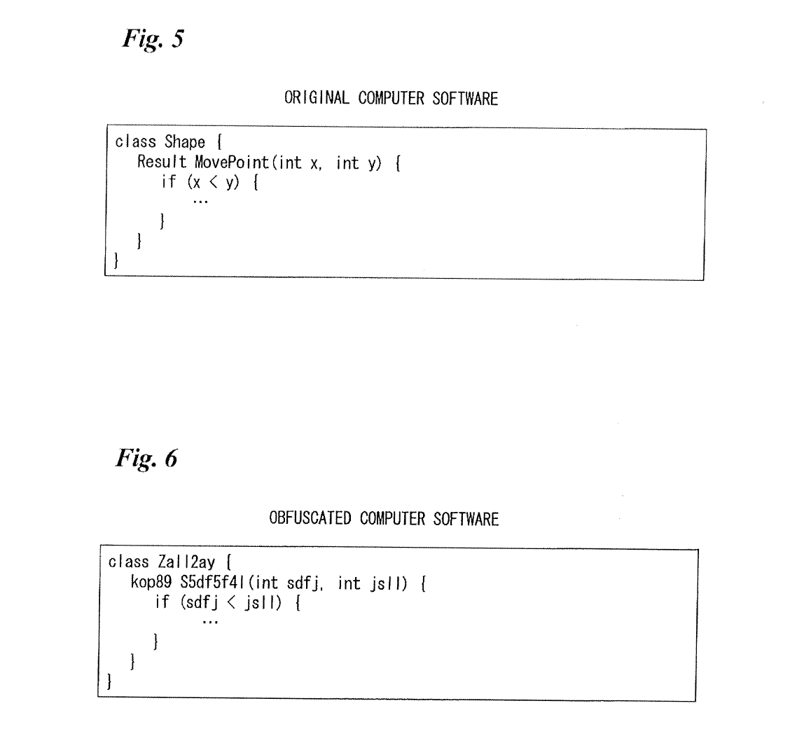

FIG. 5 is an example of the original computer software.

The first line of the computer software in FIG. 5 states the class and the second line is an example of a function.

When the original computer software that undergo analysis is input to the client computer 1, the computer software is obfuscated (step 32 in FIG. 3). Obfuscation can utilize a well-known method such as, for example, substituting random character strings for identifiers that are used in the computer software. A restoration table for restoring the obfuscated computer software to the computer software that prevailed before the obfuscation is also generated (step 32 in FIG. 3).

FIG. 6 is an example of obfuscated computer software.

A comparison of the original computer software shown in FIG. 5 with the obfuscated computer software shown in FIG. 6 clearly shows that the name “Shape” on the first line of the original computer software shown in FIG. 5 has been converted to the character string “Zall2ay” in the obfuscated computer software shown in FIG. 6. Similarly, the function “Result Movepoint (int x, int y)” on the second line of the original computer software in FIG. 5 has been converted to the character string “kop89 S5df5f41 (int sdfj, int jsll)” in FIG. 6.

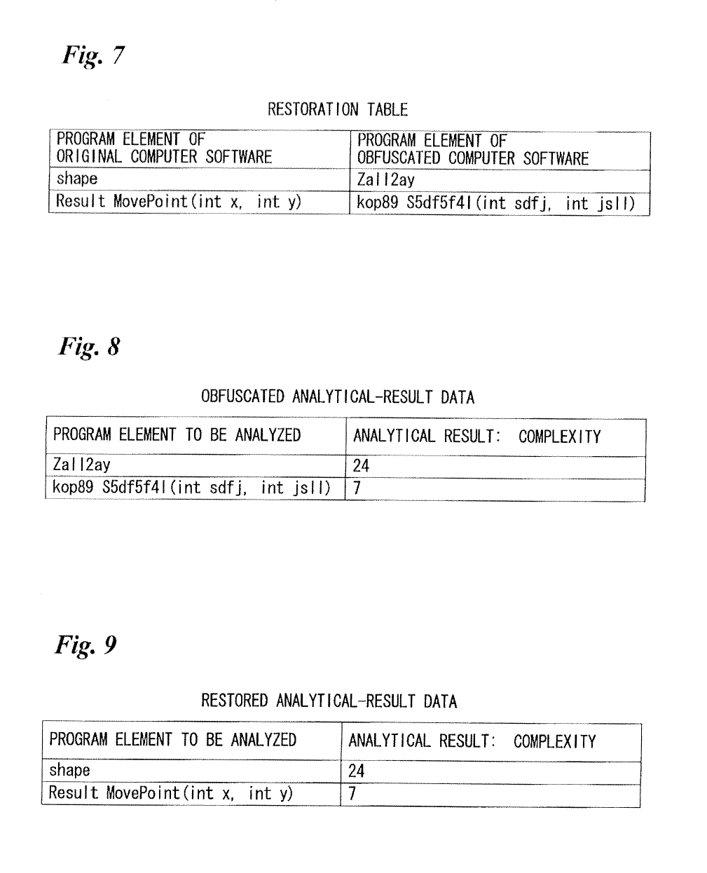

FIG. 7 is an example of the restoration table.

The restoration table can be generated by comparing the original software shown in FIG. 5 and the obfuscated computer software shown in FIG. 6.

The column on the left side of the restoration table indicates the program elements contained in the original computer software shown in FIG. 5. The column on the right side of the restoration table indicates the program elements contained in the obfuscated computer software shown in FIG. 6. The program elements before and after obfuscation can be ascertained by comparing the character strings in the column on the left side of the restoration table and the character strings in the column on the right side. It will be appreciated that the obfuscated computer software can be restored to the original computer software that prevailed prior to obfuscation by using the restoration table.

When the original computer software is obfuscated, the obfuscated computer software shown in FIG. 6 is displayed on the display screen of the display unit 3 (step 33 in FIG. 3). Upon checking the obfuscated computer software displayed on the display screen, the user inputs a transmit command from the input unit 6. In response, the obfuscated computer software is transmitted from the client computer 1 to the server computer 20 (step 34 in FIG. 3). After the user confirms that the computer software has been obfuscated, the obfuscated computer software can be transmitted to the server computer 20.

Upon receiving the obfuscated computer software transmitted from the client computer 1 (step 41 in FIG.

4), the server computer 20 executes processing for analyzing the quality of the obfuscated computer software that has been received (step 42 in FIG. 4).

The quality analyzing processing can employ a well-known method. As a result of the quality analyzing processing, analytical-result data representing, e.g., the complexity of the obfuscated computer software, is obtained. Since the quality analyzing processing is executed with regard to obfuscated computer software, the analytical-result data will be in obfuscated form as well.

FIG. 8 is an example of a table of obfuscated analytical-result data.

The column on the left side of the table of obfuscated analytical-result data indicates the program elements of the obfuscated computer software. The column on the right side of the table indicates the analytical result (complexity). It will be understood from the table of obfuscated analytical-result data that the complexity of the program element “Zall2ay” is 24 and that the complexity of the program element “kop89 S5df5f41 (int sdfj, int jsll)” is 7.

Since quality analysis has been performed with regard to the obfuscated computer software, it cannot be ascertained with regard to what kind of program element the analytical result appertains and, hence, the security of the computer software is assured.

The obfuscated analytical-result data is transmitted from the server computer 20 to the client computer 1 (step 43 in FIG. 4).

When the obfuscated analytical-result data transmitted from the server computer 20 is received by the client computer 1 (step 36 in FIG. 3), at least a portion of the obfuscated analytical-result data is restored using the restoration table (see FIG. 7) (step 37 in FIG. 3).

FIG. 9 is an example of an analytical-result data table indicating the restored analytical-result data.

The restored program elements are contained in the left column of the analytical-result data table. Complexity, which is the analytical result, is contained in the right column of the table in association with the program elements. Since the program elements have been restored, the complexity of each program element can be recognized.

The client computer 1 outputs the restored analytical-result data as by displaying it on the display screen (step 38 in FIG. 3).

FIGS. 10 to 19 illustrate another embodiment of the present invention. In this embodiment, analysis control data for controlling the quality analysis of computer software in the server computer 20 is transmitted from the client computer 1 to the server computer 20 and the quality analysis of the computer software is controlled by the server computer 20 based upon this analysis control data.

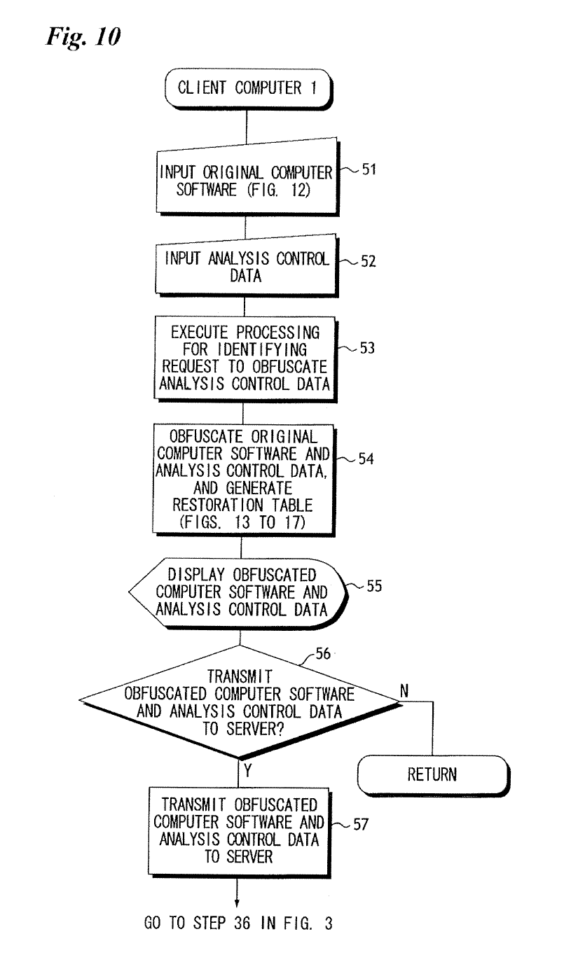

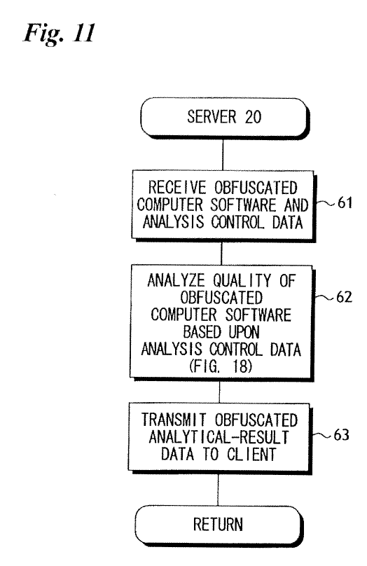

FIG. 10 is a flowchart illustrating processing executed by the client computer 1, and FIG. 11 is a flowchart illustrating processing executed by the server computer 20.

Original computer software is input to the client computer 1 (step 51 in FIG. 10).

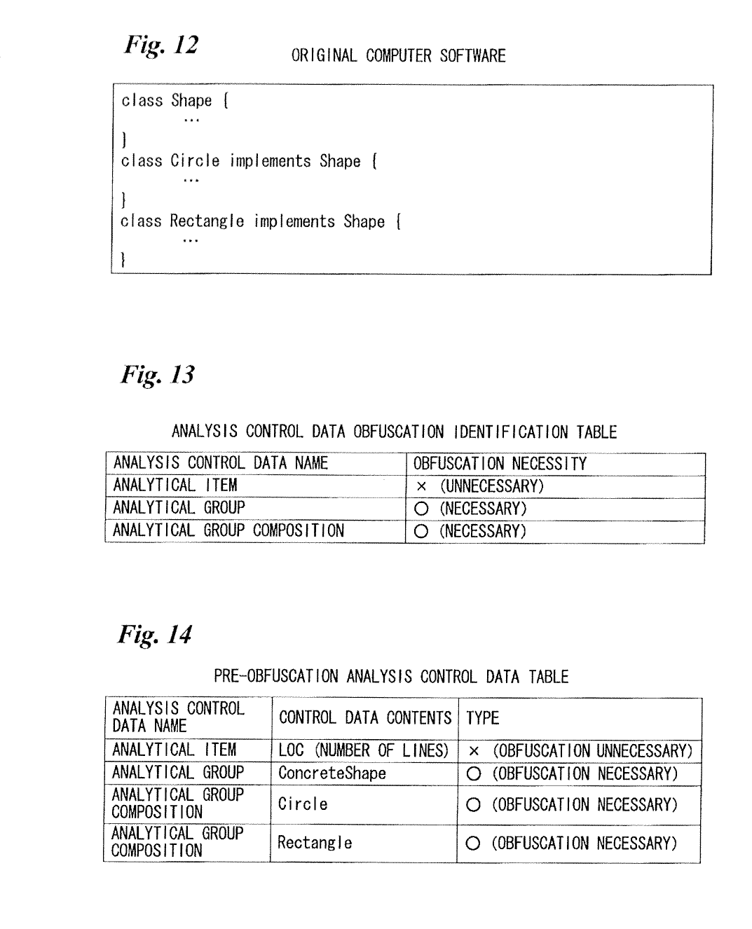

FIG. 12 is an example of the original computer software. Such original computer software is input to the client computer 1. It goes without saying that the original computer software shown in FIG. 12 is partially abbreviated.

Next, the user of the client computer 1 inputs analysis control data to the client computer 1 (step 52 in FIG. 10). The analysis control data controls quality analysis carried out in the server computer 20. The analysis control data includes analytical items such as the number of lines of program elements contained in the computer software, and the grouping of the program elements. Next, processing for identifying whether obfuscation is necessary or not is executed with regard to the analysis control data that has been input (step 53 in FIG. 10).

The processing for identifying whether obfuscation of the analysis control data is necessary or not uses an analysis control data obfuscation identification table.

FIG. 13 is an example of the analysis control data obfuscation identification table.

The column on the left side of the analysis control data obfuscation identification table contains the names of analysis control data, and the column on the right side of the table contains the necessity of obfuscation. Although “ANALYTICAL ITEM”, “ANALYTICAL GROUP” and “ANALYTICAL GROUP COMPOSITION” are indicated in the column on the left side, it goes without saying that the table contains whether obfuscation is necessary or not with regard to analysis control data other than these items of data as well. “ANALYTICAL ITEM” specifies the target of analysis, and “ANALYTICAL GROUP” controls the computer software in such a manner that the program elements of “ANALYTICAL GROUP COMPOSITION” will be grouped into the “ANALYTICAL GROUP”.

FIG. 14 is an example of a table of analysis control data prior to obfuscation.

Assume that “NUMBER OF LINES” has been designated as the “ANALYTICAL ITEM”, that “ConcreteShape” has been designated as the “ANALYTICAL GROUP”, and that “Circle” and “Rectangle” have each been designated as “ANALYTICAL GROUP COMPOSITION”. When reference is had to the analysis control data obfuscation identification table shown in FIG. 13, it can be determined that obfuscation of “NUMBER OF LINES” is unnecessary and that obfuscation of “Circle” and “Rectangle” is necessary because obfuscation of “ANALYTICAL ITEM” is unnecessary and obfuscation of “ANALYTICAL GROUP” and “ANALYTICAL GROUP COMPOSITION” is necessary.

When processing for identifying whether obfuscation of analysis control data is necessary or not is executed, the obfuscation of the original computer software is carried out and so is the obfuscation, by the same processing, of that analysis control data identified as requiring obfuscation (step 54 in FIG. 10). It goes without saying that a restoration table is generated as well.

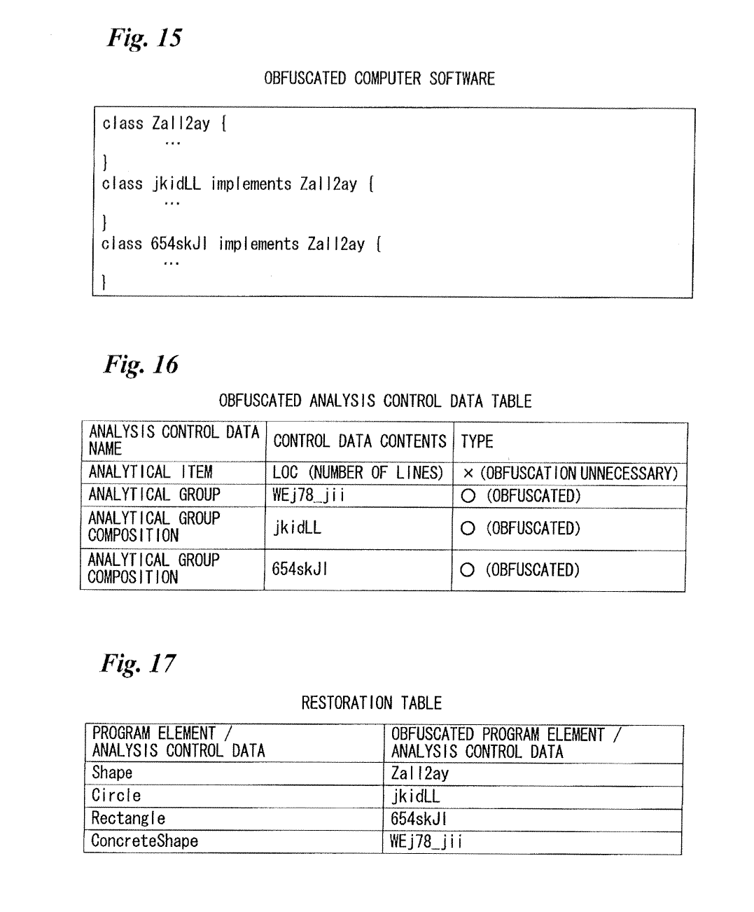

FIG. 15 is an example of the obfuscated computer software.

Owing to the obfuscation of the original computer software shown in FIG. 12, “Shape”, “Circle” and “Rectangle” of the original computer software are changed to “Zall2ay”, “jkidLL” and “654skJI” of the obfuscated computer software shown in FIG. 15.

FIG. 16 is an example of a table of obfuscated analysis control data that has been partially obfuscated.

Since the analysis control data has been obfuscated, the security of the analysis control data can be maintained even if the analysis control data is transmitted from the client computer 1 to the server computer 20 via the Internet and is intercepted by a third party.

FIG. 17 is an example of the restoration table.

In the manner described above, the restoration table is generated by comparing the original software shown in FIG. 12 and the obfuscated computer software shown in FIG. 15 and comparing the contents of the control data in the table of analysis control data prior to obfuscation shown in FIG. 14 and the contents of the control data of the table of obfuscated analysis control data shown in FIG. 16.

The column on the left side of the restoration table of FIG. 17 indicates the program elements of the original computer software or the analysis control data, and the column on the right side of the restoration table of FIG. 17 indicates the program elements of the obfuscated computer software or the obfuscated analysis control data.

The computer software that has been obfuscated and the analysis control data that has been obfuscated can be restored to the data that prevailed before obfuscation by utilizing the restoration table shown in FIG. 17.

Next, the obfuscated computer software and the analysis control data (inclusive of analysis control data that has and has not been obfuscated) are displayed on the display screen of the display unit 3 (step 55 in FIG. 10) and, in accordance with a transmit command from the user, the obfuscated computer software and analysis control data are transmitted from the client computer 1 to the server computer 20 (“YES” at step 56, and step 57, in FIG. 10).

Upon receiving the obfuscated computer software and analysis control data transmitted from the client computer 1 (step 61 in FIG. 11), the server computer analyzes the quality of the obfuscated computer software based upon the analysis control data (step 62 in FIG. 11).

By analyzing the quality of the obfuscated computer software, analytical-result data that has been obfuscated is obtained in the manner described above. The obfuscated analytical-result data is transmitted from the server computer 20 to the client computer 1 (step 63).

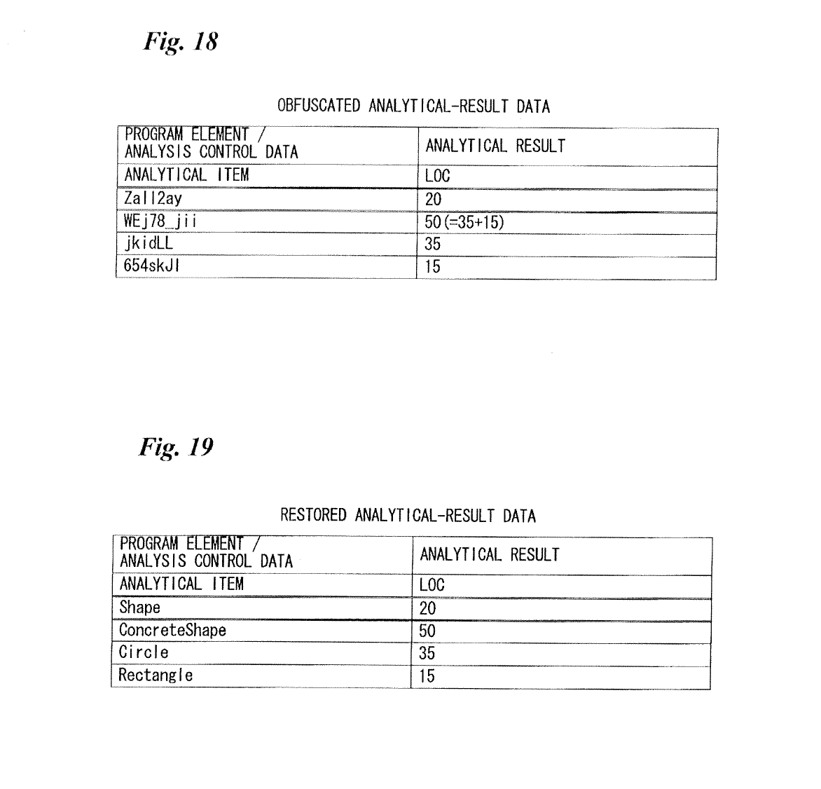

FIG. 18 is an example of analytical-result data that has been obfuscated.

The column on the left side in FIG. 18 indicates the program elements or partially obfuscated analysis control data, and the column on the right side indicates the analytical results. The analytical-result data thus obfuscated is restored using the above-described restoration table.

FIG. 19 is an example of the restored analytical-result data.

The column on the left side of FIG. 19 indicates the program elements and analysis control data restored from the obfuscated state, and the column on the right side indicates the analytical results.

Thus, analysis of computer software in the server computer 20 can be controlled from the client computer 1. Moreover, since the analysis control data transmitted from the client computer 1 to the server computer 20 has been obfuscated, greater security can be maintained with respect to third parties.

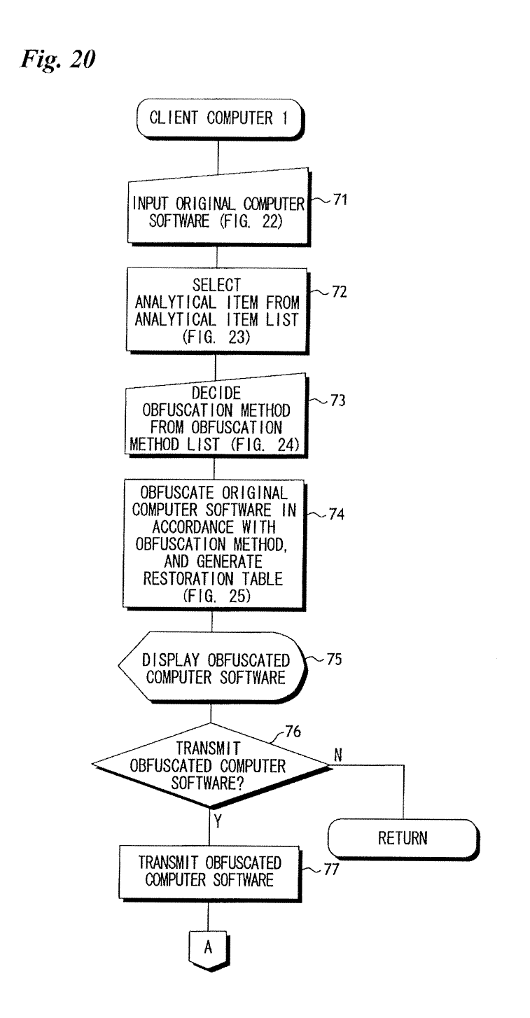

FIGS. 20 to 34 illustrate a further embodiment of the present invention.

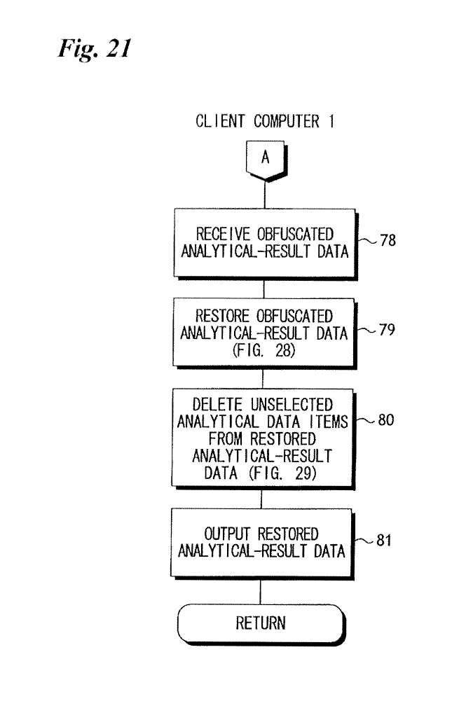

FIGS. 20 and 21 are flowcharts illustrating processing executed by the client computer 1.

Original computer software is input to the client computer 1 in a manner similar to that described above (step 71 in FIG. 20).

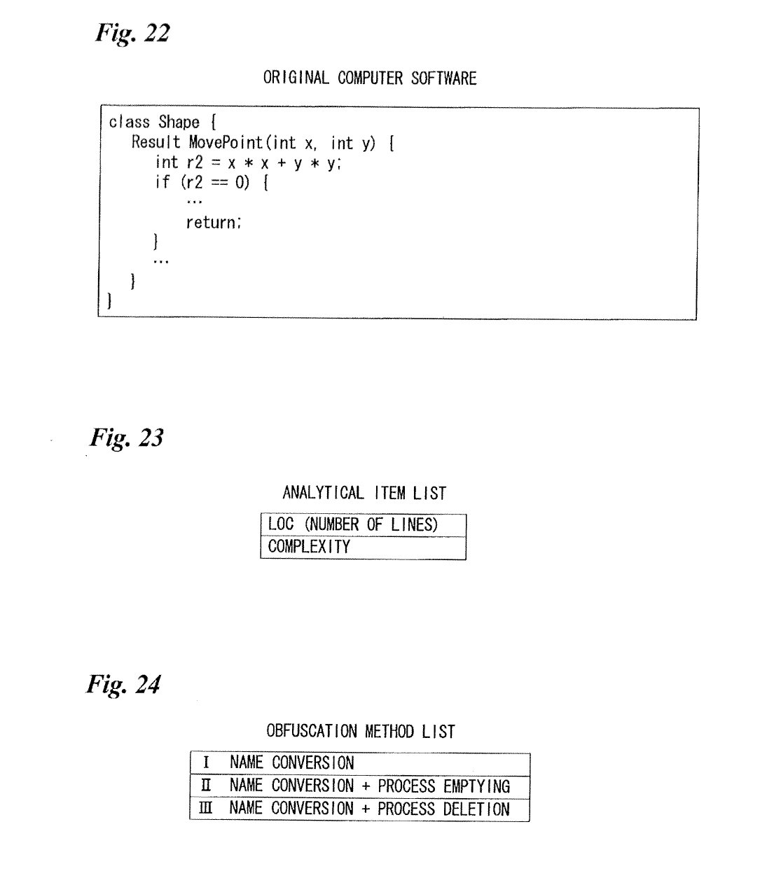

FIG. 22 is an example of the original computer software.

Since the original computer software shown in FIG. 22 has not been obfuscated, the contents thereof can be ascertained. The original computer software shown in FIG. 22 also is partially abbreviated.

The client computer 1 selects an analytical item from a list of analytical items (step 72 in FIG. 20) and selects an obfuscation method from a list of obfuscation methods (step 73).

FIG. 23 is an example of a list of analytical items.

The list of analytical items is obtained by listing up items to undergo quality analysis in the server computer 20. The list of analytical items contains number of lines of code and complexity.

FIG. 24 is an example of a list of obfuscation methods.

The list of obfuscation methods contains the following as obfuscation methods: “NAME CONVERSION”, “NAME CONVERSION+PROCESS EMPTYING” (processing for both name conversion and process emptying is executed) and “NAME CONVERSION+PROCESS DELETION” (processing for both name conversion and process deletion is executed).

The obfuscation method is decided utilizing the list of analytical items and the list of obfuscation methods. The details will be described later.

When the obfuscation method is decided, the original computer software that has been input is obfuscated in accordance with the obfuscation method decided (step 74 in FIG. 20). A restoration table is generated in this case as well.

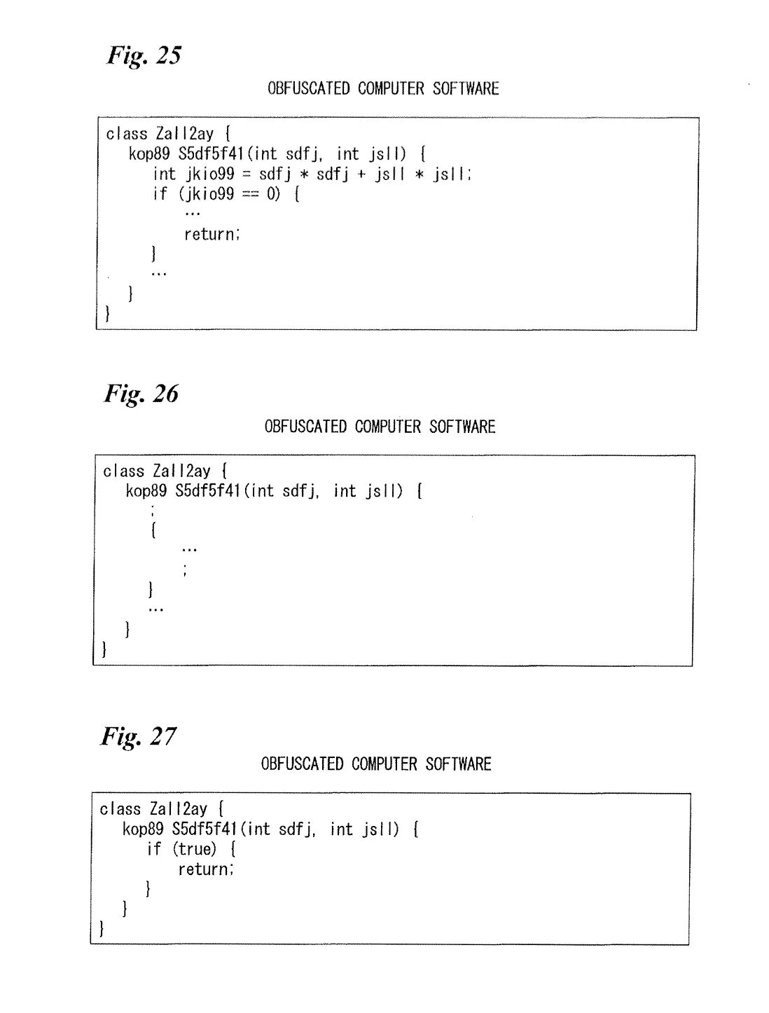

FIGS. 25 to 27 are examples of obfuscated computer software.

FIG. 25 is an example of computer software obfuscated by name conversion.

Here “Shape”, “Result Movepoint (int x, int, y)”, “int r2=x*x*+y*y” and “if (r2==0)” of the original computer software have been converted to “Zall2ay”, “kop89 S5df5f41 (int sdfj, int jsll”, “int jkio99=sdfj*sdfj+jsll*jsll” and “if(jkio99==0)”.

FIG. 26 is an example of computer software obfuscated by name conversion and process emptying.

Here “Shape” and “Result Movepoint (int x, int, y)” of the original computer software have been converted to “Zall2ay” and “kop89 S5df5f41 (int sdfj, int jsll”. Further, the processing content of each of “int r2=x*x*+y*y” and “if (r2==0)” has been emptied. Although the processing content has been eliminated due to emptying, the number of lines is unchanged. Semicolons “;” have been added on by emptying. However, obfuscation may be achieved by adding on unrelated software, such as “if(false);” for example, to the processing instead of the semicolons.

FIG. 27 is an example of computer software obfuscated by name conversion and process deletion.

Here “Shape” and “Result Movepoint (int x, int, y)” of the original computer software have been converted to “Zall2ay” and “kop89 S5df5f41 (int sdfj, int jsll”. Further, the processing content of each of “int r2=x*x*+y*y” and “if (r2==0)” has been deleted.

When the obfuscated computer software is transmitted from the client computer 1 to the server computer 20, the quality of the obfuscated computer software is analyzed and obfuscated analytical-result data obtained in the server computer 20 in the manner described above. The obfuscated analytical-result data obtained is transmitted from the server computer 20 to the client computer 1.

Upon receiving the obfuscated analytical-result data transmitted from the server computer 20 (step 78 in FIG. 21), the client computer 1 restores the obfuscated analytical-result data to obtain analytical-result data.

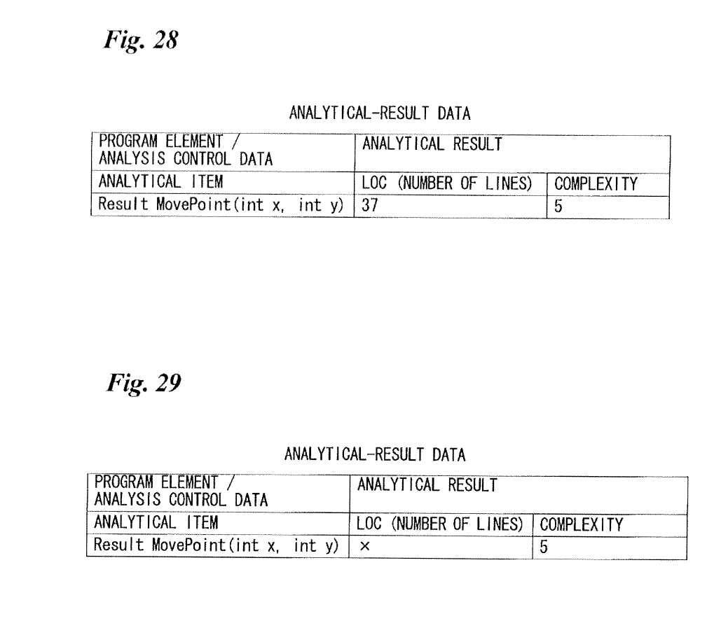

FIG. 28 is an example of restored analytical-result data.

The data contains number of lines of code and complexity as analytical items so as to be included in the list of analytical items, and quality has been analyzed with regard to these analytical items. For example, the number of lines of code is 37 and the complexity is 5.

Next, the data of analytical items that have not been selected by the analytical item selection processing (step 72 in FIG. 20) as described above are deleted from the analytical data (step 80 in FIG. 21).

FIG. 29 is an example of analytical-result data in which data regarding number of lines of code, which is an item that has not been selected, has been deleted.

Thus, when complexity has been selected as an analytical item and number of lines of code has not been selected, the data of number of lines of code is deleted from the analytical data.

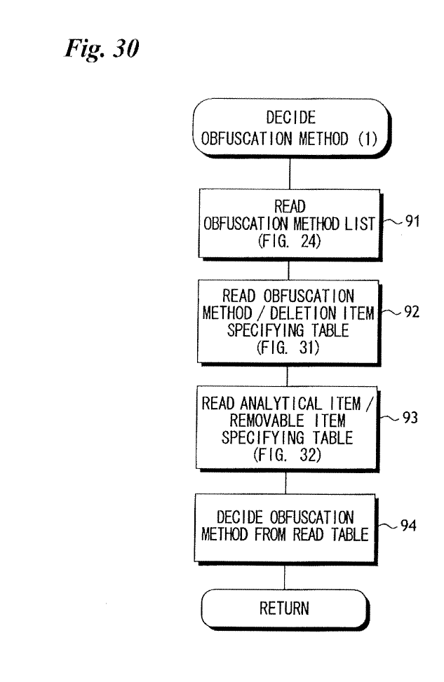

FIG. 30 is an example of a flowchart illustrating processing for deciding an obfuscation method (the processing executed at step 73 in FIG. 20).

As mentioned above, the list of obfuscation methods shown in FIG. 24 is read (step 91) and this is followed by reading an obfuscation method/deletion item specifying table (step 92).

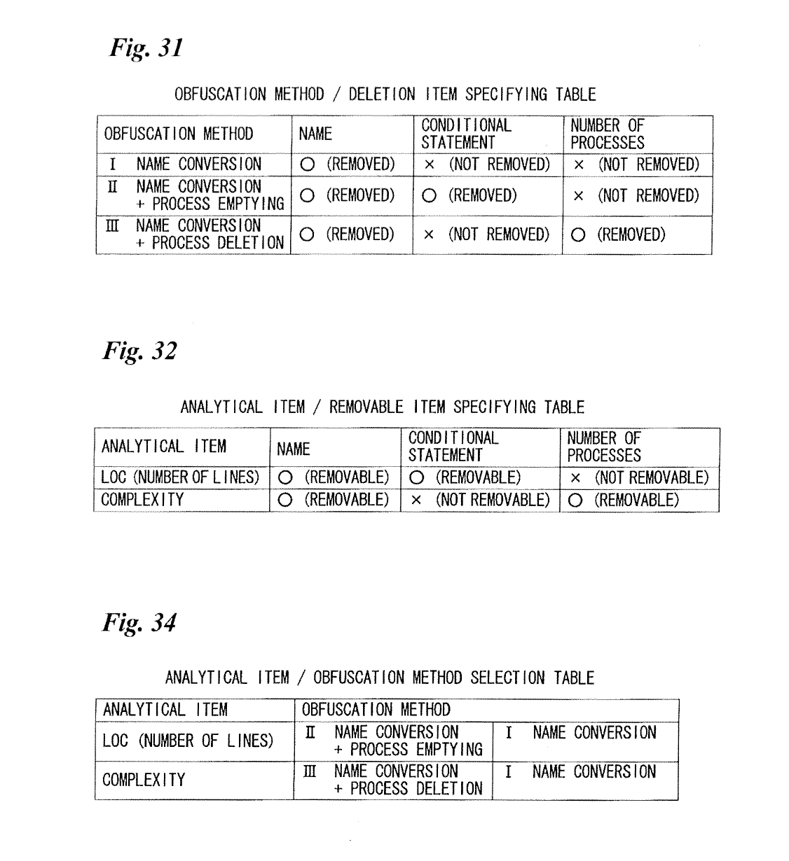

FIG. 31 is an example of an obfuscation method/deletion item specifying table.

The obfuscation method/deletion item specifying table is obtained by storing, in association with obfuscation methods, program elements of computer software that will and will not be removed. For example, if the obfuscation method is “NAME CONVERSION”, the name of the program element will be removed but the conditional statement and number of processes will not be removed. If the obfuscation method is “NAME CONVERSION+PROCESS EMPTYING”, the name and the conditional statement of the program element will be removed but the number of steps will not. If the obfuscation method is “NAME CONVERSION+PROCESS DELETION”, then the name and the number of processes of the program element will be removed but the conditional statement will not.

When the obfuscation method/deletion item specifying table is read, an analytical item/removable item specifying table is read (step 93 in FIG. 30).

FIG. 32 is an example of an analytical item/removable item specifying table.

The analytical item/removable item specifying table is obtained by storing, in association with analytical items, program elements of computer software that will and will not be removed. For example, if the analytical item is the number of lines of code, the name and the conditional statement of the program element will be removed but the number of steps will not. If the analytical item is complexity, then the name and the number of processes of the program element will be removed but the conditional statement will not.

Thus, when the table is read, the removable program element corresponding to the selected analytical item (step 72 in FIG. 20) can be ascertained from the analytical item/removable item specifying table shown in FIG. 32, and the obfuscation method corresponding to the removable program element is decided from the obfuscation method/deletion item specifying table shown in FIG. 31. For example, if “NUMBER OF LINES” is selected as the analytical item, the name and conditional statement are removable based upon FIG. 32 and “NAME CONVERSION+PROCESS EMPTYING”, therefore, is decided from FIG. 31 as the obfuscation method for which these program elements are removable.

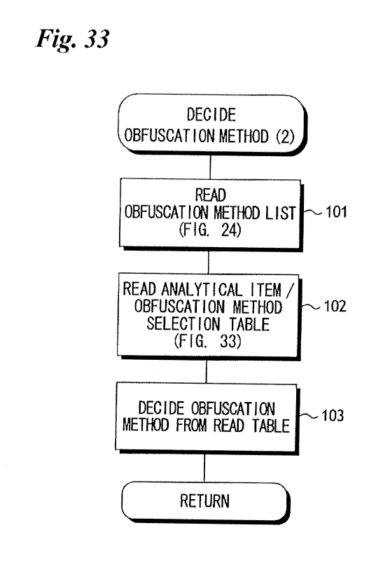

FIG. 33 is a flowchart illustrating other processing for deciding an obfuscation method.

In a manner similar to that described above, the list of obfuscation methods shown in FIG. 24 is read (step 101). Next, an analytical item / obfuscation method selection table is read (step 102).

FIG. 34 is an example of an analytical item/obfuscation method selection table.

The analytical item/obfuscation method selection table contains obfuscation methods in association with analytical items. For example, if the analytical item is the number of lines of code, then “NAME CONVERSION+PROCESS EMPTYING” and “NAME CONVERSION” are stored in association with each other. If the analytical item is complexity, then “NAME CONVERSION+PROCESS DELETION” and “NAME CONVERSION” are stored in association with each other.

When the analytical item/obfuscation method selection table is read, the obfuscation methods are decided from the read table (step 103). For example, if the number of lines of code is selected as the analytical item, then “NAME CONVERSION+PROCESS EMPTYING” and “NAME CONVERSION” are decided as the obfuscation methods. If complexity is selected as the analytical item, then “NAME CONVERSION+PROCESS DELETION” and “NAME CONVERSION” are decided as the obfuscation methods. If number of lines of code and complexity are selected as the analytical items, then “NAME CONVERSION” is decided as the obfuscation method.

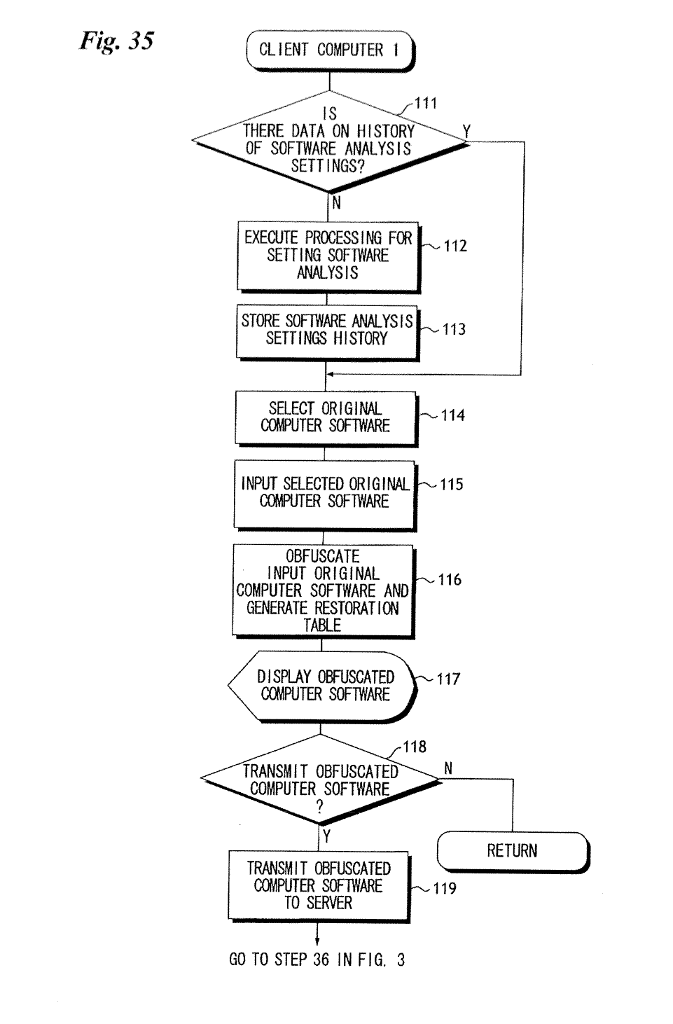

FIGS. 35 to 39 illustrate a further embodiment. This embodiment decides an obfuscation method, etc., utilizing past history.

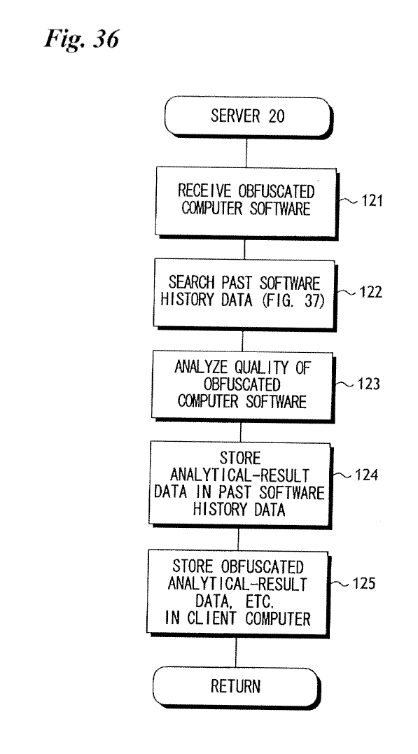

FIG. 35 is a flowchart illustrating processing executed by the client computer 1, and FIG. 36 is a flowchart illustrating processing executed by the server computer 20.

First, the client computer 1 determines whether data representing a history of software analysis settings in the past has been stored in the computer (step 111 in FIG. 35).

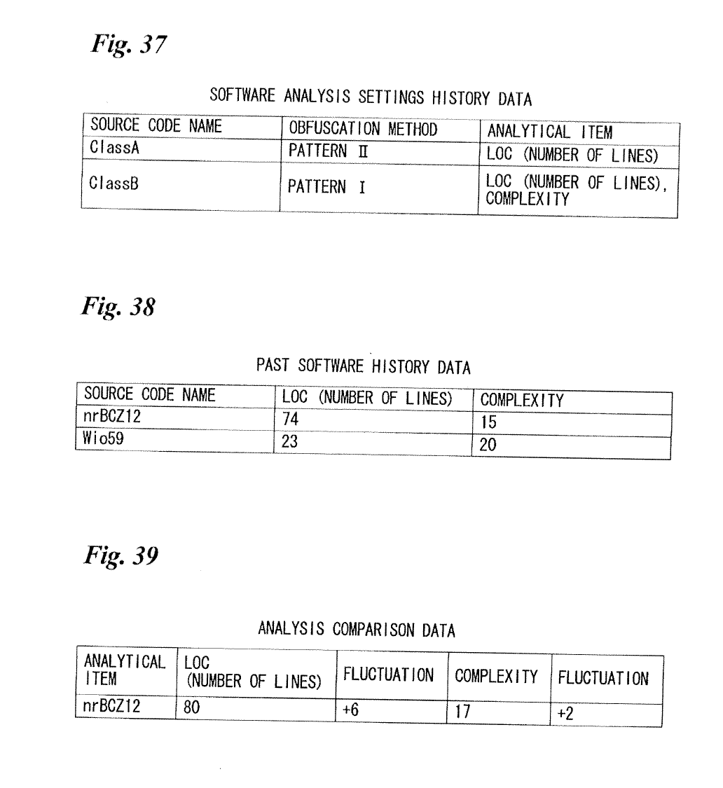

FIG. 37 is an example of a table containing data representing a history of software analysis settings.

The data representing a history of software analysis settings indicates the status of past settings, such as the decisions concerning obfuscation methods mentioned above. The first, second and third columns contain the names of source code (software), obfuscation method patterns and analytical items, respectively. By checking these items of data, it is possible to ascertain what obfuscation methods were carried out with regard to particular software in the past, and with regard to what analytical items quality analysis was performed in the past. For example, based upon the first row, with regard to source code of name “ClassA”, it can be ascertained that the obfuscation method of Pattern II (“NAME CONVERSION+PROCESS EMPTYING”) was carried out regarding the number of lines of code. Obfuscation processing identical with the obfuscation processing used in the past can be executed.

If data representing a history of software analysis settings has not been stored in the client computer 1 (“NO” at step 111 in FIG. 35), then processing for setting software analysis is carried out by the user of the client computer 1 (step 112 in FIG. 35). The analytical item and obfuscation method are set in the manner described above. When this is done, the set information is stored as data representing the history of software analysis settings (step 113 in FIG. 35). If data representing a history of software analysis settings has been stored in the client computer 1 (“YES” at step 111 in FIG. 35), the processing of steps 112 and 113 is skipped.

Next, original computer software to be analyzed is selected by the user (step 114 in FIG. 35) and the selected original computer software is input to the client computer 1 (step 115 in FIG. 35).

The original computer software that has been input to the client computer 1 is obfuscated and a restoration table generated (step 116 in FIG. 35) in the manner described above. Which obfuscation method is carried out is decided based upon the data representing the history of software analysis settings shown in FIG. 37. On the assumption that the entered source code (original computer software) is “ClassA”, obfuscation processing is executed using the obfuscation method of Pattern II (“NAME CONVERSION+PROCESS EMPTYING”), as described above.

By displaying the obfuscated computer software (step 117 in FIG. 35) and applying a transmit command to the client computer 1, the obfuscated computer software is transmitted from the client computer 1 to the server computer 20 (“YES” at step 118, and step 119, in FIG. 35).

Upon receiving the obfuscated computer software transmitted from the client computer 1 (step 121 in FIG. 36), the server computer 20 searches the past software history data (step 122 in FIG. 36). The past software history data represents the results of quality analysis performed by the server computer 20 in the past.

FIG. 38 is an example of a table containing past software history data.

The table contains number of lines and complexity, which are the results of quality analysis in the past, in association with source code names. Since the computer software has been obfuscated, the names (source code names) thereof are obfuscated, as mentioned earlier. For example, by obfuscating the computer software whose source code name is “ClassA”, the source code name is changed to “nrBCZ12”. In FIG. 38, numbers of lines and complexities have been stored in the table in association with the obfuscated source code names.

Next, the quality of the obfuscated computer software is analyzed (step 123 in FIG. 36). Analytical-result data obtained by quality analysis is stored in the table containing the past software history data (step 124 in FIG. 36). In a case where analytical-result data regarding obfuscated computer software that has already undergone quality analysis has been stored in the table of past software history data, this analytical-result data is overwritten. Past software history data is thus updated. Naturally, it may be arranged so that analytical-result data is stored in a time series without overwrite. The extent to which analytical results have changed can be ascertained by comparing analytical-result data obtained by analysis performed in the past and analytical-result data obtained by analysis performed anew.

FIG. 39 is an example of a comparison data table containing comparison data representing a comparison between analytical-result data obtained by analysis performed in the past and analytical-result data obtained by analysis performed anew.

As mentioned above, the extent to which analytical results have changed can be ascertained by comparing analytical-result data obtained by analysis performed in the past and analytical-result data obtained by analysis performed anew. The table in FIG. 39 contains data indicating fluctuation between result of analysis of number of lines performed in the past and result of analysis of number of lines performed anew, as well as fluctuation between result of analysis of complexity performed in the past and result of analysis of complexity performed anew. Thus the result of comparison with past analytical results can be obtained.

The items of obfuscated analytical-result data and data representing result of comparison with past analytical results are transmitted from the server computer 20 to the client computer 1 (step 125 in FIG. 36).

As many apparently widely different embodiments of the present invention can be made without departing from the spirit and scope thereof, it is to be understood that the invention is not limited to the specific embodiments thereof except as defined in the appended claims.

What is claimed is:

1. A computer software analysis system comprising a client computer and a server computer, wherein said client computer includes:
a computer software obfuscation device for obfuscating computer software to undergo analysis; and
an obfuscated computer software transmitting device for transmitting the computer software, which has been obfuscated by said computer software obfuscation device, to said server computer; and
said server computer includes:
a computer software analyzing device for analyzing the obfuscated computer software, which has been transmitted from said obfuscated computer software transmitting device of said client computer, and generating obfuscated analytical-result data; and
an analytical-result data transmitting device for transmitting the obfuscated analytical-result data, which has been generated by said computer software analyzing device, to said client computer;
said client computer further including a restoration device for restoring at least part of the obfuscated analytical-result data, which has been transmitted from said analytical-result data transmitting device of said server computer, to analytical-result data that prevailed prior to obfuscation.

2. The system according to claim 1, wherein said client computer includes an output device for outputting the computer software that has been obfuscated by said computer software obfuscation device.

3. The system according to claim 1, wherein said client computer further includes an analysis control data transmitting device for transmitting analysis control data, which controls analysis of the obfuscated computer software in said computer software analyzing device of said server computer, to said server computer; and
said computer software analyzing device of said server computer analyzes the obfuscated computer software by utilizing the analysis control data transmitted from said analysis control data transmitting device of said client computer.

4. The system according to claim 3, wherein said client computer further includes:
a designating device for designating, in the analysis control data, analysis control data requiring obfuscation; and
an analysis control data obfuscation device for obfuscating the analysis control data designated by said designating device; and
said analysis control data transmitting device of said client computer transmits at least one of the analysis control data obfuscated by said analysis control data obfuscation device and the analysis control data that has not been obfuscated to said server computer.

5. The system according to claim 1, further comprising:
an analytical-result control data input device for inputting analytical-result control data that controls the analytical-result data received by said client computer; and
an analytical-result data control device for controlling the obfuscated analytical-result data or analytical-result data restored by said restoration device, based upon the analytical-result control data that has been input from said analytical-result control data input device.

6. The system according to claim 1, wherein said client computer further includes an obfuscation method selecting device for selecting one obfuscation method from among a plurality of obfuscation methods; and
said computer software obfuscation device of said client computer obfuscates the computer software by the obfuscation method selected by said obfuscation method selecting device.

7. The system according to claim 1, wherein said computer software obfuscation device of said client computer deletes a part of the computer software or mixes in unrelated software and obfuscates the remaining portion of the computer software.

8. The system according to claim 1, wherein said client computer further includes:
an analytical item designating device for designating an item that will be analyzed by said computer software analyzing device of said server computer;
an obfuscation method deciding device for deciding upon an obfuscation method, which corresponds to the analytical item designated by said analytical item designating device, from among a plurality of obfuscation methods; and
a removable-portion deciding device for deciding a removable portion in the computer software in a case where obfuscation based upon the obfuscation method decided by said obfuscation method deciding device is carried out; and
said computer software obfuscation device of said client computer deletes the portion decided by said removable-portion deciding device from the computer software and obfuscates the remaining portion of the computer software.

9. The system according to claim 8, wherein a removable portion has been stipulated in the computer software in association with each analytical item and obfuscation method; and
said the obfuscation method deciding device decides an obfuscation method, which has been stipulated in association with the analytical item designated by said analytical item designating device, corresponding to the removable portion in the computer software.

10. The system according to claim 1, wherein said computer software obfuscation device of said server computer outputs the same obfuscated computer software when the same computer software is obfuscated.

11. The system according to claim 10, wherein said server computer further includes:
an analytical-result data storage device for storing analytical-result data, which has been restored in said computer software analyzing device, in association with computer software; and
a comparison device for comparing analytical-result data, which has been generated in said computer software analyzing device by analyzing the obfuscated computer software transmitted from said computer software transmitting device, and analytical-result data that has been stored in said analytical-result data storage device in association with the computer software of the generated analytical-result data, and outputting result of the comparison.

12. The system according to claim 11, wherein said client computer further includes an obfuscation method storage device for storing the obfuscation method, which has been carried out by said computer software obfuscation device of said client computer, in association with the computer software; and
said computer software obfuscation device of said client computer, when it performs obfuscation with regard to new computer software, obfuscates the computer software using the obfuscation method that has been stored in the obfuscation method storage device in association with this computer software.

13. The system according to claim 12, wherein said obfuscation method storage device of said client computer stores an obfuscation method and an analytical item, which have been implemented by said computer software obfuscation device of said client computer, in association with the computer software; and
said computer software obfuscation device of said client computer further includes an analytical item transmitting device for transmitting an analytical item, which has been stored in said obfuscation method storage device in association with new computer software, to said server computer when said computer software obfuscation device performs obfuscation with regard to the new computer software.

14. A client computer comprising:
a computer software obfuscation device for obfuscating computer software to undergo analysis;
an obfuscated computer software transmitting device for transmitting the computer software, which has been obfuscated by said computer software obfuscation device, to a server computer;
a receiving device for receiving obfuscated analytical-result data, which is generated by analyzing, in the server computer, the obfuscated computer software transmitted from said obfuscated computer software transmitting device, and which is transmitted from the server computer; and
a restoration device for restoring at least part of the obfuscated analytical-result data, which has been received by said receiving device, to analytical-result data that prevailed prior to obfuscation.

15. A method of controlling operation of a client computer comprising the steps of:
an obfuscation device obfuscating computer software to undergo analysis;
an obfuscated computer software transmitting device transmitting the computer software, which has been obfuscated by the computer software obfuscation device, to a server computer;
a receiving device receiving obfuscated analytical-result data, which is generated by analyzing, in the server computer, the obfuscated computer software transmitted from the obfuscated computer software transmitting device, and which is transmitted from the server computer; and
a restoration device restoring at least part of the obfuscated analytical-result data, which has been received by the receiving device, to analytical-result data that prevailed prior to obfuscation.

16. A computer-readable program for controlling a client computer so as to:
obfuscate computer software to undergo analysis;
transmit the obfuscated computer software to a server computer;
receive obfuscated analytical-result data, which is generated by analyzing, in the server computer, the transmitted obfuscated computer software, and which is transmitted from the server computer; and
restore at least part of the obfuscated analytical-result data received to analytical-result data that prevailed prior to obfuscation.
